(19) United States
(12) Patent Application Publication
(10) Pub. No.: US 2016/0280596 A1
(43) Pub. Date: Sep. 29, 2016

(54) Process for Remediating Alkali Silica Reactions Using a Micro Silica and Ozonation

(71) Applicant: VHSC, LTD., Tortola (VG)

(72) Inventor: Clinton Wesley Pike, SR., Montgomery, TX (US)

(21) Appl. No.: 14/798,052

(22) Filed: Jul. 13, 2015

Related U.S. Application Data
(60) Provisional application No. 62/138,116, filed on Mar. 25, 2015.

(51) Int. Cl. C04B 7/02

(52) U.S. Cl. CPC C04B 7/02

(57) ABSTRACT

A method for remediating alkali silica reactions prevents the reaction from starting by mixing a micro silica additive to an ozonated cement mix, with the micro silica constituting a micro sand that has no more than a 15-18 micron mean particle size and a top size of around 30-40 microns. In one embodiment the micro silica mixed at 8% results in a reduction in mortar expansion on average greater than 96% when used with ozonated Class C fly ash.

### CROSS REFERENCE TO RELATED APPLICATION

This application claims benefit of U.S. Provisional Application Ser. No. 62/138,116 entitled, “PROCESS FOR REMEDIATING ALKALI SILICA REACTIONS USING A MICRO SILICA” filed Mar. 25, 2015 the entire disclosure of which is incorporated herein by reference.

### FIELD OF INVENTION

This invention relates to the manufacture of cement and more particularly to the utilization of a micro silica with ozonation to remediate alkali silica reactions.

### BACKGROUND OF THE INVENTION

One of the major problems with the use of Class C fly ash is its high alkali concentration. The high alkali concentration has resulted in the banning of Class C fly ash in many states in in the manufacture of concrete. It is been found that Class C fly ash when undergoing the ASTM C441 protocol test can only achieve an average reduction in mortar expansion of 75%. Most governmental and agencies require an average reduction in mortar expansion of 74%. Since it is relatively difficult to utilize Class C fly ash and expect it to have a reduction in mortar expansion of 74%, Class C fly ash has been treated to remediate alkali silica reactions.

Alkali-silica reactions (ASR) result in premature concrete deterioration, with damage found to pre-stressed beams, abutments, columns and bents, often requiring repair of the structure or removal from service after only several years.

The damage is manifested as external and internal cracking, and as “map cracking.” The mechanisms of damage are identified as Alkali-Silica Reaction (ASR), Delayed Ettringite Formation (DEF), or both. Consequences of ASR/DEF damage are progressive loss of member function and increased susceptibility to corrosion and other forms of environmental attack.

ASR is a reaction between siliceous aggregate and high-alkali pore water in the surrounding cementitious matrix. A high alkali concentration in the pore water provides the hydroxyl ions that react with the silica to form a gel at the cementitious matrix and aggregate interface. This gel grows as it absorbs water from the environment, consequently generating expansive forces that can produce map cracking or surface pop outs.

ASR deterioration requires the following conditions: high alkali concentration in the pore water; aggregate with reactive silica; and water.

Heretofore, the goal for treating existing ASR-affected structures is to prevent water infiltration. At the same time, the treatment should permit the escape of water already in the structure, so that it does not continue to promote the reaction. Accordingly, the treatment, whether a penetrating coating or an encapsulation, must be impermeable to liquid water and permeable to water vapor.

It will be appreciated that all he above treatments either require coated particles or are used as sealants once the concrete has been made. There is therefore a need to be able to prevent the alkali silica reactions from occurring at all, and to do so prior to forming mortar or making concrete.

By way of further background, prior ASR remediation techniques include modified Portland cement, epoxy, polyurethane, methyl-methacrylate, silane, and acrylic resins. Up to the present time, penetrating hydrophobic sealers have the greatest potential for controlling expansion from ASR/DEF. While not completely impermeable to water, they are permeable to water vapor. Silane has been found to reduce chloride-ion content. Silane was especially effective at reducing chloride- and sulfate-ion ingress, carbon-dioxide intrusion, and weathering when applied with an acrylic topcoat. Silane systems remain breathable. Boiled linseed oil performed as well or better than silane and siloxane in tests for salt-water and chloride intrusion. Linseed oil is inexpensive, but may need more frequent reapplication than other penetrating sealers. However all of these mediation solutions are expensive and do not necessarily work as well as they should. Moisture-cured urethanes although expensive have promise for treating existing structures because of their need for moisture. Controlling the rate of cure so that moisture-cured urethanes can penetrate the concrete surface may improve their effectiveness at reducing expansion from ASR/DEF. High-molecular-weight methacrylate (HMWM) has been reported as both a penetrating sealer and crack sealer. As will be appreciated, in all the types of concrete deterioration, water is the common factor.
For freeze/thaw cycles and lowered resistivity, water is the root of the problem.
Sulfate attack, salt scaling, and ingress of chloride all require water to transport the sulfate, salt, or chlorides that are the cause of the deterioration.
Water is the agent that allows CO2 to create carbonation damage due to mortar expansion.

Similarly, an external source of water is required for ASR/DEF deterioration. Many of the mitigating or remediating treatments for sulfate attack, salt scaling, freeze/thaw cycling, ingress of chlorides, carbonation, and lowered resistivity seek to prevent water infiltration, and therefore may be applicable as treatments for ASR/DEF deterioration.

A large body of literature has been accumulated over many years related to surface treatments, penetrating sealers, epoxies, and crack sealers for the purpose of keeping water out of concrete and thereby mitigating or remediating concrete deterioration. Nonetheless, a better method for remediating alkali silica reactions is required.

### SUMMARY OF THE INVENTION

In order to remediate alkali silica reactions it has been discovered that using a micro silica or microsand filler along with ozonation of the base Class C fly ash as described in U.S. Pat. No. 8,967,506 issued to Clinton Wesley Pike on Mar. 3, 2015, describes ozonation to prevent alkali silica reactions from occurring at all. It is been found that using the microsand filler; after ozonation one can obtain a reduction in mortar expansion as much as 97.2%. This is compared to 74% when utilizing ozonated Class C fly ash without microsand. Non ozonated Class C fly without microsand a mortor expansion of 48%, Thus, the further addition of the microsand filler stunningly virtually eliminates mortar expansion for Class C fly ashes. The result is that the use of ozonation and the microsand permits the use of Class C fly ash where heretofore it was banned. It will be appreciated that sand is an extremely inexpensive material that can be obtained at no more than $25 per ton, whereas silane costs up to seven dollars per gallon. Moreover, it has been found that the use of the microsand far exceeds the performance of silane in remediating alkali silica reactions. Additionally, all that is needed to generate the microsand is a reactor to grind up the sand.

By microsand is meant a silica sand micro filler having no more than a 15-18 micron mean particle size and a top size of around 30-40 microns. More specifically, the sand should have a surface area of around 3.0 m2/gm. When added at 4-8% by weight of fly ash to an ozonated Class C fly ash the result is considerable ASR remediation according to the ASTM C441 test. In one embodiment, the addition of the structural micro silica resulted in a 97.2 rating versus the same sample of Class C fly ash without microsand which only reached a 75 rating, with both being ozonated. Moreover, if one were to try to limit the alkali reaction by substituting Class F fly ash for Class C fly ash, one can only obtain an 87.6% reduction in mortar expansion.

As used herein, the percentage of microsand refers to the percentage of microsand in the microsand/fly ash mixture, or more particularly to the weight percent of microsand to the weight percent of the fly ash in the fly ash/microsand mixture, as opposed to the percentage of microsand in cement.

What has thus been discovered is that rather than using coatings, surface treatments, penetrating sealers, epoxies, and crack sealers, a new way to control ASR uses superfine silica sand and ozonation of the Class C fly ash described earlier as a treatment system for Class C fly ash in all cement mixtures where ASR is an issue.

Moreover it has been found almost no loss of strength occurred when using the microsand which means the micro silica acts as a structural filler, filling in air or water gaps while keeping the mixture at the same strength as compared to when micro silica is not added.

The use of microsand corresponding to silica sand ground down below an 18 micron mean particle size with a top size of under 40 microns stops alkali silica reactions before they start and thus remediates the alkali silica reaction problem. By using a surface area of—3.0 m2/g as a reference one can use 4% by weight of said additive. It will be appreciated that the micro silica is used—as an additive to the cement mix rather than as a penetrating or crack sealer applied to hardened concrete and rather than as a coating or membrane applied to the surface of concrete.

In summary, a technique for remediating alkali silica reactions prevents the reaction from starting by ozonating the Class C fly ash and then mixing a micro silica additive to the cement mix, with the micro silica constituting a micro sand that has no more than 18 micron mean particle size and a top size of 40 microns. Alternatively stated, one can use 4% of a 3.0 m2/g or finer surface area sand.

In one embodiment the micro silica with a top size of 40 microns mixed at 8% with an ozonated fly ash results in an average reduction in mortar expansion of greater than 96% when using Class C fly ash. In another embodiment, a finer sand was used, namely 3.0 m2/gm material, and at 4% nonetheless produces a 96% reduction in expansion.

### DETAILED DESCRIPTION

By way of further background, and more specifically a number of techniques have been utilized in the past to remediate alkali silica reactions:

### POLYMER-MODIFIED CEMENT MORTAR (PCM)

Heretofore, mediation of ASR has involved two coatings, one impermeable to water and the other permeable to water vapor, in reducing ASR-related expansion. The impermeable coating consisted of three layers of epoxy. The vapor-permeable coating consisted of silane followed by a flexible polymer-modified cement mortar (PCM). In tests, specimens with the vapor-permeable coating showed continuous negative expansion, whereas after six months the specimens with the impermeable coating had much greater expansion than the uncoated specimens. The investigators attribute this high expansion to the excess initial pore water that could not escape through the impermeable epoxy coating.

The above tests measured the performance of several concentrations of a PCM using the criteria of water permeability, water-vapor permeability, elongation, adhesion, and expansion of a concrete specimen in the field. Water permeability and water-vapor permeability decreased with increasing polymer ratio, with the lowest permeability corresponding to the greatest tested polymer ratio, 0.75. Elongation of the PCM increased as the polymer ratio increased. Adhesion was greatest for a polymer ratio of 0.525.

The PCM-coated specimens had consistently low expansion, while the uncoated and epoxy-coated specimens had much higher overall expansion and greater rates of expansion. As the water-vapor permeability of the PCM increased, the specimens' expansion decreased.

### SILANE- AND URETHANE COATING

The silane and urethane coatings were applied to newly constructed specimens when their moisture content had reduced to 10%. In the outdoor series, silane- and urethane-coated specimens had expansion equivalent to that of a non-reactive specimen, actually showing negative expansion. Epoxy-coated and methyl-methacrylate-coated specimens expanded severely and the coatings cracked. Sodium silicate-coated specimens showed expansion equivalent to that of the uncoated reactive specimens. All specimens had very high expansion under cycles of wetting and drying. Expansion was found to be related to ratios of surface area to volume and treated surface area to total surface area. As those ratios increase, expansion decreases. It was concluded that structures with large ratios of surface area to volume would especially benefit from surface treatment. The final series of tests was a comparison of the performance of silane, silane with a PCM cover, and silane with a methyl-methacrylate cover under cycles of wetting and drying. Silane/PCM-coated specimens had four times the expansion of specimens with the other two coatings after 32 weeks of exposure, but still less than all specimens from the first series of tests.

### LITHIUM-BASED SOLUTION

In the past a lithium-based solution was used to treat ASR. Tests were conducted to compare the penetration ability of various lithium solutions, to assess the efficacy of the best solution, and to study how the timing of the treatment influenced this efficacy. Penetration ability was assessed by placing various lithium salt solutions at several concentrations in cavities in cylinders, and then recording the volume of solution entering the cylinder. The greatest penetration was achieved with a 30% lithium nitrate solution with a blend of surfactants, surpassing the penetration of lithium hydroxide, formate, and acetate. Reactive mortar bars and concrete prisms were then used to study efficacy and application timing. In reactive mortar bars, one-half the amount of lithium required as an admixture to control ASR reduced expansion to as little as 55% of that of uncoated control specimens. Also, lithium nitrate reduced expansion twice as much as lithium hydroxide. The lithium nitrate was used on concrete prisms, applied in one and five coats. The one-coat specimens exhibited 0.1% expansion and the 5-coat specimens exhibited 0.05% expansion. The investigators concluded from the timing tests on both mortar bars and concrete prisms that some prior expansion aided penetration, and thus effectiveness, by inducing cracking. Existing cracks provided a path for the coating to penetrate.

Electrochemical chloride extraction, used to drive chloride ions out of salt-contaminated structures, can easily be adapted to drive lithium ions into a structure. The potential benefits are shortened treatment time and an increase in the effective amount of lithium in the structure. The anode for the process is a titanium-coated metallic mesh, the same as is often used for cathodic protection and chloride extraction. Reinforcement in the structure is the cathode. The impressed current comes from AC/DC rectifiers, which convert high-voltage AC to low-voltage DC. Lithium solutions supply the lithium ions and act as the electrolyte providing electrical continuity between the anode and cathode. An electric field is created between the mesh and reinforcement. Lithium, being a positive ion, is driven away from the mesh and toward the reinforcement, and is thus distributed in the concrete. Field application to bridge decks in Virginia and Delaware, carried out by the investigating companies, showed rapid migration of the ion into the concrete in the first week of treatment. Each treatment period lasted eight weeks. No samples were taken to determine the total lithium content at the end of treatment.

### COATINGS AND MEMBRANES

Coatings and membranes include epoxies, polymer cements, and urethanes. All of these provide a layer on the surface of the concrete. Membranes are impermeable to water, while coatings may or may not be impermeable.

### PENETRATING SEALERS

Penetrating sealers are solutions or suspensions that diffuse into the concrete near the surface. These include silane, siloxane, oils, high-molecular-weight methacrylate (HMWM), and penetrating epoxies. While not impermeable to liquid water, they create a hydrophobic layer, sometimes (as in the case of silane and siloxane) by chemical reaction with the concrete. Because they are clear, penetrating sealers offer the advantage of permitting continued observation of the concrete surface.

### CRACK SEALERS

Crack sealers are low-viscosity, flexible polymers applied specifically to cracks in reinforced concrete. Ideally, they penetrate the crack completely, thus eliminating an easy path for water entrance, and also restore structural strength to the member. Crack sealers include HMWM, epoxies, and urethanes.

Polymer-modified cement mortar (PCM), silane, urethane, and lithium nitrate were found to be effective in reducing expansion from ASR. In some tests, the products were used as two-coat systems, such as silane with a PCM topcoat, with good results. Several references, however, report that epoxy promotes expansion. Methyl-methacrylate and sodium silicate are also not effective at reducing expansion. Lithium can be used either in an applied solution or in an electrochemical process. Lithium nitrate is more effective and safer to use than lithium hydroxide. In the electrochemical process, lithium ions are driven into the concrete toward the reinforcement. The benefit of this process is an increase in the amount of useful lithium deposited in the concrete. Lithium is successful at reducing ASR expansion, but because it is not a hydrophobic sealer, it does not have the added benefit of protecting against other forms of deterioration.

### MICRO SILICA

Rather than using the above remediation techniques, it is been found that micro silica or micro sand with ozonation of the parent cementitious material being used, including high alkali cements, when used as an additive in the cement results in an unusual reduction in mortar expansion As a baseline, in terms of ASTM testing protocol C441, as can be seen from Table I below for raw un-ozonated Class C fly ash with a 50-50 mix with Ordinary Portland Cement, the reduction in mortar expansion is on the order of 71%, too low to be acceptable. Normally Class C fly ash that has not been ozonated varies from 48-71%. This characteristic of raw Class C fly ash makes it unsuitable for use structural concrete and is banned by many states due to the cracking and deterioration that can be expected.

As can be seen from Table II below for raw ozonated Class C fly ash with a 50-50 mix with Ordinary Portland Cement the reduction in mortar expansion is only 73.7%, still under the 75% acceptability.

As shown in Table III below, if one seeks to remediate alkali silica reactions one can mix Class C fly ash with Class F fly ash, in one embodiment using a 10%-90% mixture. The best remediation when mixing Class F fly ash at 8% with ozonated Class C fly ash is 87.6% in terms of the reduction of mortar expansion. While acceptable, it has been found that this can be markedly improved with the addition of micro silica.

If the subject micro silica is mixed with ozonated Class C fly ash at 8%, when mixed 50-50 with Ordinary Portland Cement, the amount of reduction in mortar expansion as shown in Table 1V below is 97.2%, a reduction which is unheard of in the cement making industry. This is almost complete elimination of mortar expansion, which means that any alkali silica reaction is prevented before it starts.

TABLE I
Raw Class C Fly Ash
50-50 mix with Ordinary Portland Cement
(non-ozonated)

| | Specimen Expansion, % | | | | | | | |
|---|---|---|---|---|---|---|---|---|
| | Control Mixture | | | | Test Mixture | | | |
| Age, days | A | B | C | Average | A | B | C | Average |
| 1 | 0.000 | 0.000 | 0.000 | 0.000 | 0.000 | 0.000 | 0.000 | 0.000 |
| 14 | 0.060 | 0.060 | 0.064 | 0.061 | 0.016 | 0.022 | 0.016 | 0.018 |

Reduction in Mortar
pecimen Expansion, %

| Age, days | A | B | C | Average |
|---|---|---|---|---|
| 1 | 0.0 | 0.0 | 0.0 | 0.0 |
| 14 | 73.3 | 63.3 | 75.0 | 71 |

TABLE II
Raw Class C Fly Ash
50-50 mix with Old Portland Cement
(ozonated)

| | Specimen Expansion, % | | | | | | | |
|---|---|---|---|---|---|---|---|---|
| | Control Mixture | | | | Test Mixture | | | |
| Age, days | A | B | C | Average | A | B | C | Average |
| 1 | 0.000 | 0.000 | 0.000 | 0.000 | 0.000 | 0.000 | 0.000 | 0.000 |
| 14 | 0.157 | 0.163 | 0.160 | 0.160 | 0.052 | 0.038 | 0.036 | 0.042 |

Reduction in Mortar
pecimen Expansion, %

| Age, days | A | B | C | Average |
|---|---|---|---|---|
| 1 | 0.0 | 0.0 | 0.0 | 0.0 |
| 14 | 66.9 | 76.7 | 77.5 | 73.7 |

TABLE III
Class C Fly Ash (ozonated),
Class F Fly Ash (un-ozonated 8%)
50-50 mix with Ordinary Portland Cement
(ozonated)

| | Specimen Expansion, % | | | | | | | |
|---|---|---|---|---|---|---|---|---|
| | Control Mixture | | | | Test Mixture | | | |
| Age, days | A | B | C | Average | A | B | C | Average |
| 1 | 0.000 | 0.000 | 0.000 | 0.000 | 0.000 | 0.000 | 0.000 | 0.000 |
| 14 | 0.103 | 0.092 | 0.097 | 0.097 | 0.014 | 0.014 | 0.008 | 0.012 |

Reduction in Mortar
pecimen Expansion, %

| Age, days | A | B | C | Average |
|---|---|---|---|---|
| 1 | 0.0 | 0.0 | 0.0 | 0.0 |
| 14 | 86.4 | 84.8 | 91.8 | 87.6 |

TABLE IV
Class C Fly Ash, Micro Silica 8%
50-50 mix with Ordinary Portland Cement
(ozonated)

| | Specimen Expansion, % | | | | | | | |
|---|---|---|---|---|---|---|---|---|
| | Control Mixture | | | | Test Mixture | | | |
| Age, days | A | B | C | Average | A | B | C | Average |
| 1 | 0.000 | 0.000 | 0.000 | 0.000 | 0.000 | 0.000 | 0.000 | 0.000 |
| 14 | 0.103 | 0.092 | 0.097 | 0.097 | 0.002 | 0.003 | 0.003 | 0.003 |

Reduction in Mortar
pecimen Expansion, %

| Age, days | A | B | C | Average |
|---|---|---|---|---|
| 1 | 0.0 | 0.0 | 0.0 | 0.0 |
| 14 | 98.1 | 96.7 | 96.9 | 97.2 |

The importance of the utilization of micro silica for prevention of alkali silica reactions cannot be understated. The subject micro sand can be used in any cement or concrete manufacturing process to remediate alkali silica reactions by preventing them in the first place. Thus the term remediation may not be applicable to the subject process due to the fact that the alkali silica reaction is prevented from occurring. In one sense it would be more appropriate to refer to the above process as alkali silica reaction prevention.

As such the subject technique offers a completely new way to eliminate mortar expansion, whether with ozonated or un-ozonated fly ash. Moreover, it is an inexpensive technique that merely involves grinding down common sand which is readily available to cement manufacturing operations. Sand reactors include commonly available grinding or milling apparatus or may include sophisticated rotary mills.

While the above tests have been performed with micro silica ground down to 1.6 m² per gram, it has been found that utilizing a finer micro silica, one having a surface area of 3.0 m² per gram allows one to use less additive and still achieve the same results. This is a result of taking the surface area higher.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for remediating alkali silica reactions in cement comprising the steps of adding a micro silica filler to an ozonated cement mixture.

2. The method of claim 1, wherein the micro silica filler is mixed with one of Class C fly ash or Class F fly ash.

3. The method of claim 1, wherein the addition of the micro silica filler to and ozonated reactive substrate prevents alkali silica reactions from occurring.

4. The method of claim 1, wherein the micro silica filler is comprised of sand particles.

5. The method of claim 4, wherein the sand particles have a mean particle size of no more than 18 microns and a top size of no more than 40 microns or have a 3.0 m2/g surface area.

6. The method of claim 4, wherein the sand particles have a mean particle size of 15-18 microns and a top size of 30-40 microns.

7. The method of claim 1, wherein the average reduction in mortar expansion exceeds 96%.

8. The method of claim 7, wherein the fly ash is a Class C fly ash.

9. The method of claim 8, wherein the amount by weight added to the fly ash mixture of the micro silica filler is between 2% and 10% of the weight of the fly ash.

10. The method of claim 7, wherein the cement mixture comprises a 50-50 mixture of fly ash and micro silica filler with old Portland cement.

11. A cement mixture comprising ozonated fly ash and a micro silica filler.

12. The cement mixture of claim 11, wherein the micro silica filler includes sand particles and wherein the sand particles have a mean particle size of no more than 18 microns and a top size of no more than 40 microns, or wherein the sand particles have a surface area of 3.0 m2/gm or higher.

13. An alkali silica reaction remediated cement mixture comprising ozonated fly ash and a micro silica filler.

14. A cement mixture that prevents alkali silica reactions in cement comprising ozonated fly ash and a micro silica filler.

15. The cement mixture of claim 14, wherein the micro silica filler includes sand particles and wherein the sand particles have a mean particle size no more than 18 microns and a top size no more than 40 microns.

16. The cement mixture of claim 14 wherein the micro silica filler includes sand particles wherein the sand particles have a surface area of 3.0 m2/gm or higher.

17. The cement mixture of claim 14, wherein the amount of micro silica filler added to the fly ash is less than 8% by weight.

18. The cement mixture of claim 14 wherein the amount of micro silica filler added to the ash is 4% by weight of a 3.0 m2/gm or higher surface area sand.

19. The cement mixture of claim 14, wherein the cement mixture is mixed 50-50 with Old Portland Cement.

20. The cement mixture of claim 14, wherein the fly ash is selected from the group consisting of Class C fly ash and Class F fly ash.

21. The cement mixture of claim 14, wherein the average reduction in mortar expansion is above 96%.

22. A cement mixture comprising fly ash and a micro silica filler.

23. The cement mixture of claim 22, wherein the micro silica filler includes sand particles and wherein the sand particles have a mean particle size of no more than 18 microns and a top size of no more than 40 microns, or wherein the sand particles have a surface area of 3.0 m2/gm or higher.

24. An alkali silica reaction remediated cement mixture comprising fly ash and a micro silica filler.

25. A method for stopping alkali silica reactions in high alkali Ordinary Portland Cement, comprising the steps of:
ozonating fly ash;
mixing the ozonated fly ash with micro silica to form an ozonated micro silica infused fly ash; and,
mixing the ozonated micro silica infused fly ash with Ordinary Portland Cement, whereby the micro silica stops alkali silica reactions.
